(19) United States
(12) Patent Application Publication
(10) Pub. No.: US 2026/0030188 A1
(43) Pub. Date: Jan. 29, 2026

(54) Systems and Methods for Superconducting Integrated Circuits on a Chip Involving Electron Quantum Waves, Cryogenic Radiation-Shielded Packages, Quantum Wave Devices and/or Other Features

(71) Applicant: Georg Gesek, Vienna (AT)

(72) Inventor: Georg Gesek, Vienna (AT)

(21) Appl. No.: 19/344,341

(22) Filed: Sep. 29, 2025

Related U.S. Application Data
(63) Continuation of application No. PCT/US2024/021818, filed on Mar. 27, 2024.
(60) Provisional application No. 63/454,960, filed on Mar. 27, 2023.

(51) Int. Cl. G06F 13/362; G06N 10/40

(52) U.S. Cl. CPC G06F 13/362; G06N 10/40

(57) ABSTRACT

Systems and methods of the disclosed technology relate to hybrid integrated superconducting systems, superconducting components such as quantum wave shutters, quantum multiplexers, quantum wave memories and/or other disclosed aspects. In one example embodiment, a superconductor Metal-Oxide-Semiconductor (SMOS) chip is disclosed containing one or more superconducting components on a single die, wherein the one or more superconducting components may include a classical computing system or devices, a quantum computing system and/or devices that manipulate and control quantum waves, and a signal conversion subsystem that transforms signals between classical subsystems and quantum subsystems in order to establish a connection between classical and quantum information. Additional aspects relate to quantum devices and their structure(s) such as quantum wave shutters, quantum multiplexers and/or quantum wave memories, among other innovative systems, devices, features and functionality disclosed herein.

### CROSS-REFERENCE TO RELATED APPLICATION(S) INFORMATION

This is a (bypass) continuation of International Application No. PCT/US2024/021818, filed 27 Mar. 2024, published as WO2025/170602A2, on 14 Aug. 2025, and claims benefit of/priority to U.S. provisional patent application No. 63/454,960, filed Mar. 27, 2023, all of which are incorporated herein by reference in entirety.

### FIELD

The disclosed technology relates to the field(s) of computer science, integrated circuits (ICs) and chip manufacturing, (quantum) information theory, quantum physics, computer architecture, processing and storing of quantum and classical information, devices and packaging with their physical structure.

### BACKGROUND

As explained in further context, below, systems, chips and devices herein may be manufactured by established chip fabrication techniques in the industry, such as metal-oxide-semiconductor (MOS) or other technologies and implementations. In some implementations, existing production processes may not need to be altered in order to implement the printed circuits for superconducting materials. Some suitable materials to create such circuits on a MOS chip are described in further detail below. Other chip fabrication techniques and materials may also be utilized, in other implementations of the disclosed technology.

Example background technologies associated with and/or used to fabricate devices and circuits on a chip herein may require pure superconducting conditions in distinct geometries, where outside of such conditions the insulator of the metal oxide may prohibit the movements of electrons within the crystal lattice. With regard to such illustrative technologies and/or substrates, one example are those involving barium highly doped silicon as a superconductor (Ba8Si46). In addition to that one example, however, the disclosed technology may be implemented with other combinations of super- and semiconductor materials, including but not limited to, germanium as semiconductor or niobium nitride (NbNₓ), with a TC around 16K, as superconductor, as well as by other technologies. For example, other such viable chip manufacturing technologies may include those associated with and/or noted in a niobium nitride Superconducting Quantum Interference Device on a chip, such as those described in the paper entitled “On-Chip Integrable Planar NbN NanoSQUID with Broad Temperature and Magnetic-Field Operation Range” by Itamar Holzman and Yachin Ivry (https://[ ]), and especially those technologies, substrates, devices, device structures and associated superconducting device characteristics, parameters, and/or Josephson junctions/effect reflected in both the cited references and in the detailed fabrication process(es) set forth in the ‘Supplementary Material’ section.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a vertical section of an integrated cryogenic shielded package, consistent with exemplary aspects of certain implementations of the disclosed technology.

FIG. 2 depicts a horizontal section of an integrated cryogenic shielded package, consistent with exemplary aspects of certain implementations of the disclosed technology.

FIG. 3 depicts an illustrative block diagram of such a hybrid integrated superconducting systems on a chip with both classical and quantum computation devices and capabilities, consistent with exemplary aspects of certain implementations of the disclosed technology.

FIG. 4 depicts an illustrative implementation of a superconducting quantum wave shutter on an industrially fabricable chip, consistent with exemplary aspects of certain implementations of the disclosed technology.

FIG. 5 depicts an additional view of a superconducting quantum wave shutter on an industrially fabricable chip, consistent with exemplary aspects of certain implementations of the disclosed technology.

FIG. 6 depicts an illustrative arrangement of cascading superconducting quantum wave shutters, consistent with exemplary aspects of certain implementations of the disclosed technology.

FIG. 7 depicts a horizontal section of a superconducting quantum wave memory, consistent with exemplary aspects of certain implementations of the disclosed technology.

### DETAILED DESCRIPTION OF ILLUSTRATIVE IMPLEMENTATIONS

Apparatuses, systems, devices, design and methods for superconducting integrated circuits on a chip using electron quantum waves and/or quantum electronics are disclosed. Further, illustrative physical implementations and aspects of integrated hybrid quantum and classical information processing on a single microchip, die or set of interconnected chip are described. In some embodiments, the following physical architecture of novel integrated superconducting devices and circuits may be based on industry standard silicon as a monolithic crystalline semiconductor platform and/or wafer. For example, the described physical implementation of hybrid quantum & classical integrated circuits (HQCIC) may be manufactured by established chip fabrication techniques in the industry, such as metal-oxide-semiconductor (MOS) or other technologies and implementations. In some implementations, existing production processes may not need to be altered in order to implement the printed circuits for superconducting materials. Some suitable materials to create such circuits on a MOS chip are described in further detail below. Other chip fabrication techniques and materials may also be utilized, in other implementations of the disclosed technology.

The later-described functions of the novel devices and circuits on a chip may require pure superconducting conditions in distinct geometries, where outside of such conditions the insulator of the metal oxide may prohibit the movements of electrons within the crystal lattice. These superconducting conditions may be present at 4 Kelvin absolute temperature. Such properties may be met, in one example, by barium highly doped silicon as a superconductor (Ba8Si46, with a critical temperature (TC) around 8 Kelvin). Nonetheless, the disclosed technology may be implemented with other combinations of super- and semiconductor materials such, as germanium as semiconductor or niobium nitride (NbNₓ), with a TC around 16K, as superconductor, as well as by other technologies. As noted above, for example, superconductor manufacturing technologies and superconductor devices may be, in one exemplary embodiment, implemented via niobium nitride superconducting quantum interference device on a chip, e.g., as disclosed in “On-Chip Integrable Planar NbN NanoSQUID with Broad Temperature and Magnetic-Field Operation Range” by Itamar Holzman and Yachin Ivry and the references and Supplementary Materials therein, though with such technologies utilized to implement the superconducting switching structures herein as opposed to the passive superconducting devices, as there.

In some embodiments, the physical structure on the chip may be planar, e.g., constructed by implantation of extraneous ions, constructed with atomic layer disposition (ALD), though other shapes and technologies may be utilized. The chosen materials for the superconductor and the techniques of building the structures may influence the conditions of mass production but is not subject to the principle function of the hybrid quantum and classical integrated circuits (HQCIC) as described below. In either case, the hybrid quantum and classical integrated circuit (HQCIC) systems and methods herein may be based on the combination of super- and semiconductors, using metal oxide intermediary layers, which overall create the new techniques for the implementation of such integrated circuits, referred to herein as Superconductor-Metal-Oxide-Semiconductor (SMOS), as will be described in further detail below. This allows the superconducting switching circuits, both for classical and quantum signal processing herein to be much smaller, with a structure width under 10 nm (nanometer), other than shown for the NanoSQUIDs in the above-mentioned Holzman et al. paper, where their passive device (i.e., resistor, capacitor, etc.) structure widths are introduced in the 100's of nanometers.

### Overview of Aspects of the Disclosed Technology

Implementations of the systems described herein may include and/or involve, though are not limited to, one or more of the aspects described below.

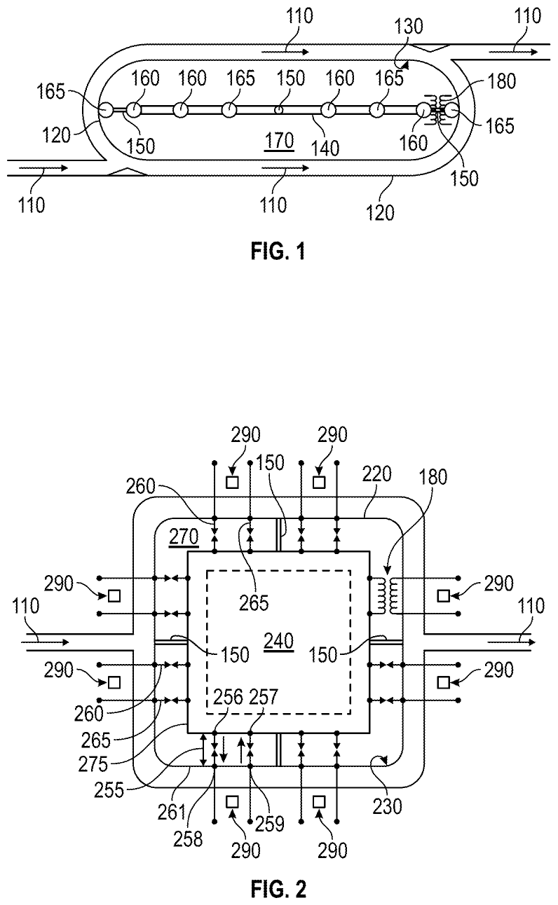

FIGS. 1 and 2 depict, respectively, a vertical cross-sectional view and a horizontal cross-sectional view, of an integrated cryogenic shielded package, consistent with exemplary aspects of certain implementations of the disclosed technology. Here, a first implementation of an integrated cryogenic shielded package for superconducting microchips is disclosed, which includes a cryogenic cooling mechanism with liquid Helium-4, the shielded, evacuated cavity and integrated electromagnetic input/output devices for both, power supply with low frequencies and data interchange with high frequencies of electromagnetic radiation, as depicted in FIGS. 1 and 2.

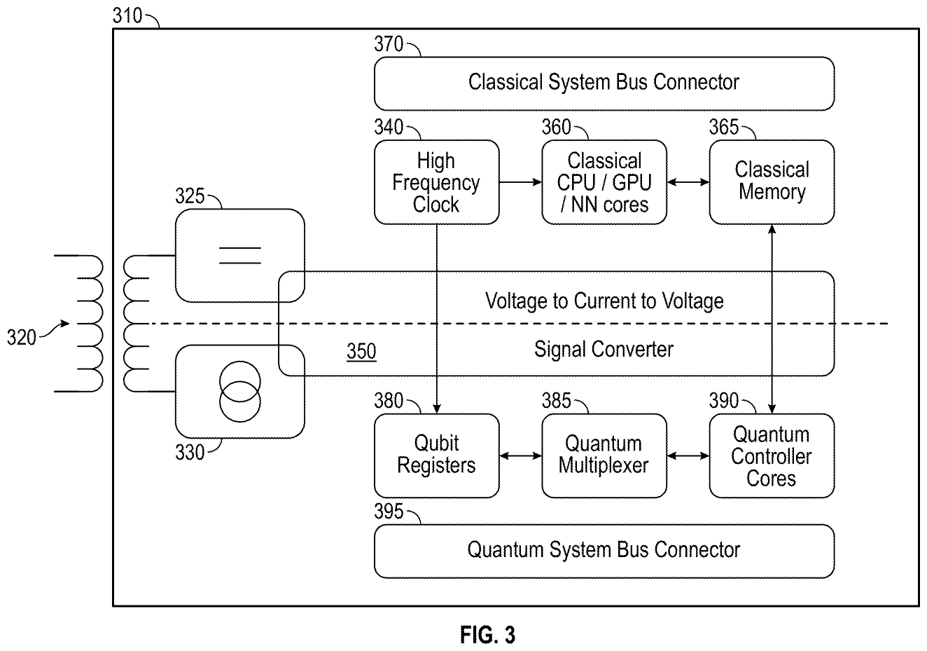

FIG. 3 depicts an illustrative block diagram of such hybrid integrated superconducting systems on a chip with both classical and quantum computation capabilities, consistent with exemplary aspects of certain implementations of the disclosed technology. FIG. 3 illustrates a first implementation of integrated superconducting systems on a chip which includes voltage source driven classical signal and data processing architectures as well as current source driven quantum wave and information processing architectures on the same die, as shown in FIG. 3.

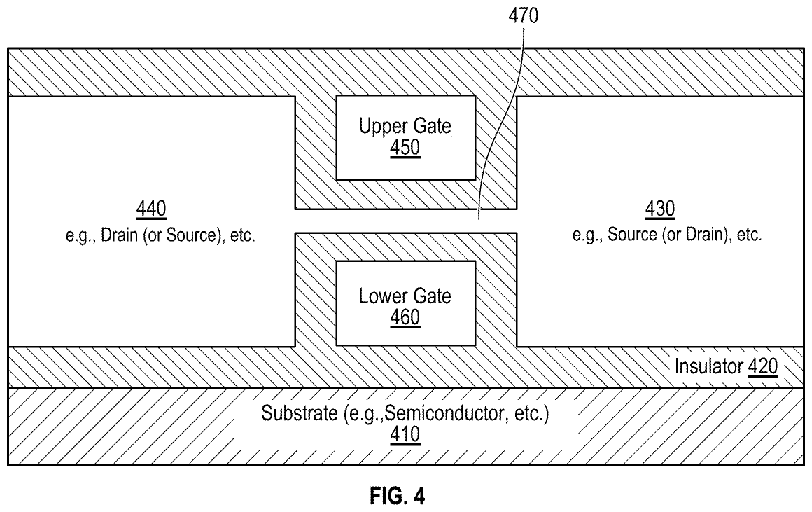

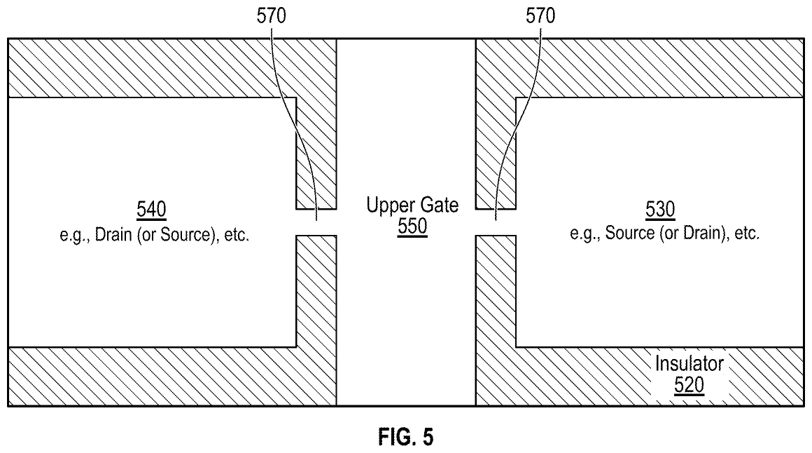

FIGS. 4 and 5 depict illustrative implementations and views of a superconducting quantum wave shutter on an industrially fabricable chip, consistent with exemplary aspects of certain implementations of the disclosed technology. Here, such superconducting quantum wave shutter as integrated device on a SMOS chip is suitable for mass production and integration on the nanometer scale, and is depicted in FIGS. 4 and 5. Here, it is especially noted that the usage of the delocalized property of the superconducting electrons as quantum waves to be switched within the device is contrary to classical electrons in a field effect transistor.

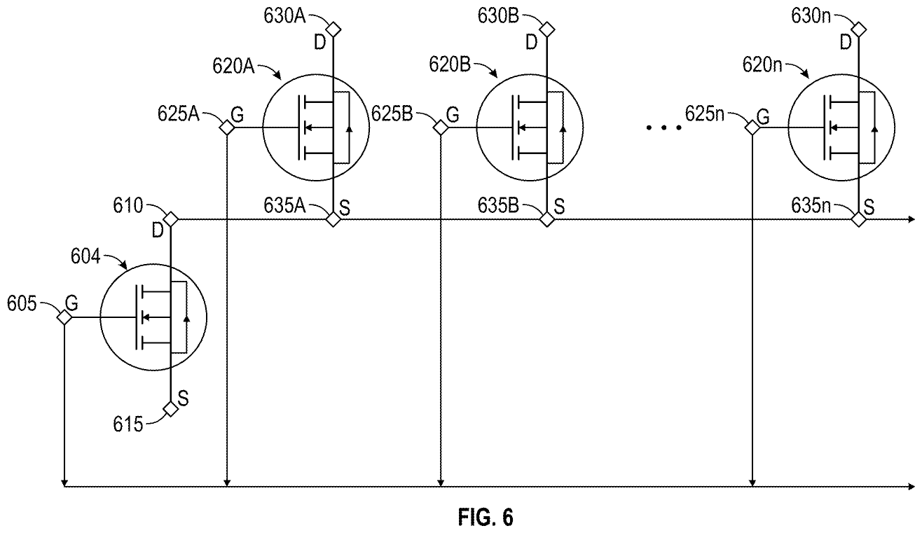

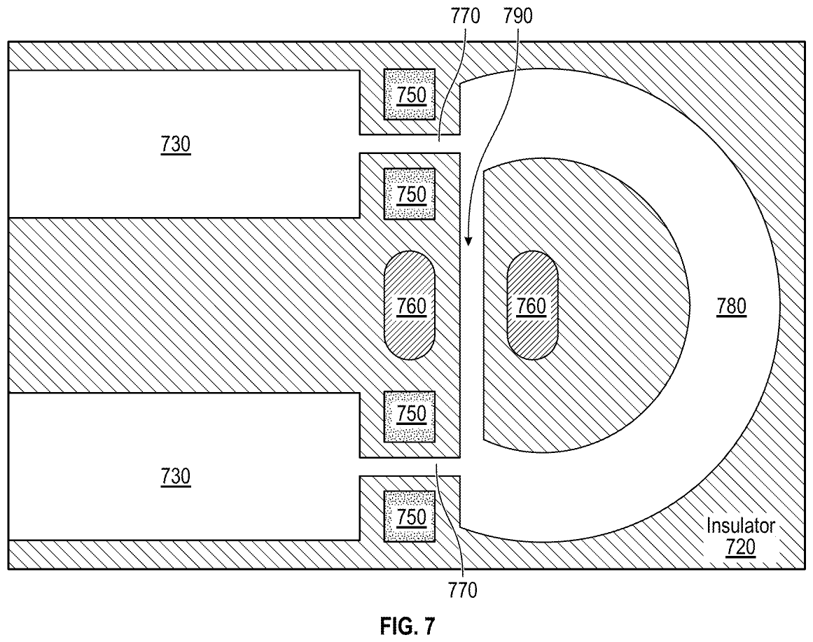

FIG. 6 depicts an illustrative arrangement of cascading superconducting quantum wave shutters, consistent with exemplary aspects of certain implementations of the disclosed technology. Here, aspects of a quantum wave multiplexer as intrinsic application of a flexible cascaded formation of a number of superconducting quantum wave shutters, providing quantum wave distribution, superposition (interference) and entanglement at the same time are illustrated, as shown in FIG. 6.

FIG. 7 depicts a horizontal section of a superconducting quantum wave memory, consistent with exemplary aspects of certain implementations of the disclosed technology. Here, an exemplary superconducting quantum wave memory as integrated device on a SMOS chip suitable for mass production and integration on the nanometer scale is illustrated, as depicted in FIG. 7. Embodiments, here, may especially pertain to aspects involving the space-time interaction free manipulation of the electron quantum waves due to field effects and their storage in a circulator.

Further, as also set forth herein, the present systems and methods may include aspects of direct current superconducting qubits, as described in further detail below. Here, for example, some implementations involve the usage of the amount of momentum of the electrons within the superconducting electron quantum wave as quantum information resource and its direction as the encoding for a classical bit of information.

Embodiments herein may include quantum gate and circuit implementation based on the superconducting quantum wave shutter, the quantum wave multiplexer, the superconducting quantum wave memory and the direct current superconducting qubits, as described in further detail below. Here, for example, innovations may involve multi qubit controlled NOT (CNOT) gate implementation(s) by using entangled electron quantum waves coming from the quantum wave multiplexer as well as the rotation gate implementation by amplitude ratio control between the two entrance electrodes (source) at one superconducting quantum wave memory.

Certain implementations herein are also based on scalable chip-level integrated electron quantum wave systems with their capacity of being connected via the quantum system bus connector (e.g., 395 in FIG. 3, etc.) to other chip-level integrated electron and photonics quantum wave systems.

### SMOS Chip Architectures

Some conventional chip architectures, both for semiconductors and superconducting integrated circuits, inherently function by applying voltages on integrated devices and trying to control frequencies within a wide spectrum. The resulting currents are treated as a necessary byproduct in order to make the integrated devices function. With semiconductors, the currents may produce heat, which is an undesirable outcome. Even some conventional superconducting chip designs treat the currents as accidental outcome of the desired functionality for data processing. By contrast, the systems described herein leverage the strength of the currents in the superconducting integrated circuits for information gathering within quantum sensing devices.

The following describes a new quantum electronics method and device architecture to process classical and quantum information within the same superconducting circuits while using the integrated devices designed to apply and control superconducting currents to a high precision. In some embodiments, classical circuits may also function on the same chip without heat dissipation due to the novel architecture of Superconducting Field Effect Transistors (S-FET). Systems and methods described herein provide improvements to the field of superconducting integrated circuits for both classical voltage sourced and quantum current sourced devices.

### Integrated Cryogenic Shielded Package (ICSP)

In order to operate, a SMOS must be cooled to operating temperature and shielded from the environment. In some embodiments, a SMOS may also require a power inlet and/or high-speed signal links to external components in order to perform data processing functionality. The SMOS structure with the devices may be constructed not to dissipate heat during operation, facilitating the electrical currents to remain superconducting all time. In some examples, a minimal amount of heat loss may occur due to radiation. In some implementations, this lost heat may be absorbed by an integrated cryogenic shielded package cooling system that is inbuilt into the novel packaging technique.

In some embodiments, an integrated cryogenic shielded package may be a fully integrated packaging system for superconducting chips working at a designated operating temperature (e.g., an operating temperature above 4 Kelvin). An integrated cryogenic shielded package may perform various functions, including (i) shielding the microchip from outside influences such as temperature fluctuations, electromagnetic radiation and/or mechanical vibrations, (ii) providing the chip with power, (iii) providing the chip with high-frequency connections to the outside environment (e.g., to other device components, external devices, etc.), (iv) cooling the inner part of the chip (e.g., to 4 Kelvin), and/or (v) absorbing thermal radiation and/or gas.

FIG. 1 illustrates a vertical section of an integrated cryogenic shielded package while FIG. 2 illustrates a horizontal section of an integrated cryogenic shielded package, consistent with exemplary aspects of certain implementations of the disclosed technology. In one embodiment, inbuilt heat pipes may carry liquified Helium-4 110 to various parts of the chip. In some implementations, a cavity 170 inside the hull may be evacuated from air as shown in FIG. 1 or cavity 270 as shown in FIG. 2, e.g., to form a vacuum. In some examples, the vacuum may interrupt the transport of the heat from a barrier 120 or 220 to a chip 140 or 240, respectively. The inner surface of the hull 130 or 230 may condensate the remains of gas inside the cavity 170 or 270, respectively, and absorb thermal radiation produced by the chip during operation. The chip itself may be mounted by heat insulating bars 150 to hull 120 or 220, respectively.

Both, low frequency power source 180 and high frequency data channels 160, 165 and/or 260, 265 may be implemented as vacuum transmission channels with electromagnetic radiation bridging the gap 255 between the sending devices 256 and the receiving devices 257 on the chip 275 (or 160) and their counterparts, the receiving devices 258 and the sending devices 259, built into the wall or hull 220 (also 120), e.g., across or via channels 160, 165 and/or 260, 265, to the outside. The wall-mounted parts may be conventionally attached to the power source. In some embodiments, the superconducting chip may receive its energy to operate from an electromagnetic induction system 180. The chip outside may be connected by conventional gold metal pins 290 to a printed circuit board for operation within a whole computer system.

### Integrated Superconducting Systems on a Chip (ISSOC)

In some embodiments, the number of applications and/or systems that may be integrated on such a superconducting microchip is enormous. The following describes the fundamental principles to reach a high accuracy in manipulating signals on this novel superconducting chip platform which in turn become valuable sources for data processing providing highest frequency and bandwidth capabilities. The described systems may be capable of both the support of classical chip architectures as well as novel systems on a chip due to the superconducting qualities of the SMOS structure.

Classical integrated circuits for data processing may commonly comprise three integrated devices, namely transistors, capacitors and resistors. Inductors may be less common, especially for data processing purposes. Transistors and capacitors may function with superconducting circuits very similarly to their counterparts on semiconductor implementations. In some examples, the resistors may be differently implemented and may be substituted by small gaps within the superconducting path, providing both a voltage reduction as well as a quantized magnetic field in between.

For these classical circuit implementations, the systems described herein provide the advantage of good cooling capabilities of the chip due to a relatively high (e.g., 4 Kelvin, etc.) operating temperature. This functionality may enable a broad variety of applications such as x86 or ARM cores integrated and operated on the SMOS chip within the integrated cryogenic shielded package. The anticipated clock frequencies of such systems may be located well above 100 GHz, providing great improvements compared to the current semiconductor implementations. The classical integrated circuits may be powered by traditional voltage sources, which can be derived from the integrated cryogenic shielded package integrated power source.

Various novel chip and package designs consistent with the present innovations allow for another, even more powerful data processing approach, which is based on superconducting currents and their high precision timed control. The whole electrical superconducting circuit may run without any resistors or Josephson Junctions and may not use voltage sources but current sources instead. The electrical currents in such circuits may not be defined by a voltage which is applied to a resistor, which produces unwanted heat in the system, but set up by a high frequency and precise clock that produces pulses of superconducting current that are then be recognized as waves traveling through the circuit paths. These waves may not interact with the environment nor the superconductor in which they are propagated. Without any interaction, the signals may become quantum mechanical and may not dissipate. ISSOCs on the novel SMOS platforms herein therefore may maintain THz frequencies even in highly complex circuits for applications in need of high clock speeds, such as signal and data processing.

FIG. 3 depicts the block diagram of such a hybrid ISSOC with both classical and quantum computation capabilities, consistent with exemplary aspects of certain implementations of the disclosed technology. In one embodiment, a chip 310 may be isolated from the environment in a way that the incoming energy does not exceed a predetermined limit (e.g., 4 Kelvin in one illustrative implementation, etc.) of black body radiation, such as via an integrated cryogenic shielded package described above. The energy to operate the chip in this case may be inserted by an electromagnetic coupling from the outside environment 320. The induced electrical energy may then be converted, for example, to a direct voltage (DV) source 325 and/or a direct current (DC) source 330. Such DV source may drive a high frequency generator 340 that provides a highly stable source for timing over the whole chip architecture and may be further calibrated by an outside reference clock via a classical system bus connector 370. In some embodiments, the result of such architecture results in a known, stable resonator which provides real-time coherence in the THz region. In such implementations, this may then be the source for the classical data processing circuits 360, classical memory 365 and/or, via the voltage to current signal converter 350, the quantum data processing units, namely the qubit registers 380, quantum multiplexer 385 and/or quantum controller 390. The quantum controller may consist of several computational cores itself and may in turn be attached to the classical memory via a current to voltage signal converter 350. In this way, a coherent parallel processing of classical and quantum information becomes applicable. Finally, the classical 370 and the quantum 395 bus connectors may allow the superconducting microchip to connect to other similar or compatible systems on a chip. The quantum system bus connector 395 may be capable of the direct connection of qubits 380 and their quantum information via entanglement initiated by the quantum multiplexer 385. The classical system bus connector 370 may allow for the similar transaction for classical bits in the memory 365 via Direct Memory Access (DMA). In some embodiments, cache coherency with other systems may be implemented in various ways, such as via the Compute Express Link (CXL) standard.

### Superconducting Quantum Wave Devices (SQWD)

The ISSOC is designed to bring together existing semiconductor circuit layouts with minimal changes powered by voltage sources with novel sophisticated current driven superconducting quantum wave circuits onto one single chip platform. In order to do so, certain systems and methods described herein may require one or more of the following three novel and universal superconducting devices which let quantum waves pass or reflect, distribute and store.

### Superconducting Quantum Wave Shutter (SQWS)

A superconducting quantum wave shutter may be described as the quantum analog to a classical field effect transistor. The superconducting quantum wave shutter may let quantum waves pass or may reflect the quantum waves by the application of an electrical field to a channel where the quantum wave is set to pass. The systems described herein may use the same superconducting quantum wave shutter for classical signal/data processing applications as well as quantum information processing by operating the superconducting quantum wave shutter either with the voltage, or alternatively to the current source. In embodiments involving a voltage source, the signal manipulation behavior of the superconducting quantum wave shutter is comparable to a classical transistor, switching on and off a current between source and drain of the device. In embodiments where the superconducting quantum wave shutter is powered by the current source, and e.g. with timing restricted to the main clock and the direct manipulation of quantum waves in their own timeframe coherently derived from the current source, the same superconducting quantum wave shutter device may be utilized for the signal processing of quantum information by passing and reflecting quantum waves.

FIG. 4 illustrates an illustrative implementation of the superconducting quantum wave shutter on an industrially fabricable chip, consistent with exemplary aspects of certain implementations of the disclosed technology. FIG. 5 illustrates a horizontal section of an exemplary superconducting quantum wave shutter, consistent with exemplary aspects of certain implementations of the disclosed technology. As illustrated in FIGS. 4 and 5, the whole integrated device may reside on a silicon monocrystalline waver 410 where layers of metal oxide 420 or 520 are applied. Within the metal oxide, which insulates against electrical currents, the superconducting material 430 or 530, 440 or 540, 450 or 550, 460 and 470 or 570 may be applied. The quantum waves may come in from source 430 or 530 and find a narrow superconducting pathway 470 or 570, respectively, in the size that the superconducting electron quantum waves may pass in a low number of modes. In some embodiments, the exact diameter and/or other parameters of pathway 470 or 570 may be set as a function of the superconducting material and the applied voltages. The connection of a voltage source at the upper 450 or 550 and lower 460 gate may apply an electric field to the narrow pathway 470 or 570 that undermines its superconducting capabilities. At a certain point, the number of available superconducting modes for the incoming quantum waves may vanish to zero. At that point, the electron quantum waves face the electrical field between the gates 440, 450, and/or 550 as a barrier that can be high enough relative to their energy to be repelled from the passage to drain electrode 440 or 540. This may result in a shutter mechanism for the superconducting currents within the circuit controlled by the gate electrodes.

### Quantum Wave Multiplexer (QWMX)

In order to produce superpositioned and entangled states in a quantum wave circuit, a system must be able to distribute, realign and merge quantum waves into a single device, e.g., a quantum bit (qubit). Such a quantum wave multiplexer, or short quantum multiplexer 385 as shown in FIG. 3, may be achieved by cascading superconducting quantum wave shutters as illustrated in FIG. 6. The quantum waves may easily be split into arbitrary many pathways in the superconducting circuit. Each of these superconducting paths may be controlled by gate-synchronized superconducting quantum wave shutter. The merging process on a superconducting quantum wave memory (SQWM) in order to create a qubit within the superconducting quantum wave memory is discussed in greater detail below.

FIG. 6 illustrates exemplary superconducting quantum wave shutters as field-effect-transistor-like symbols that are connected by integrated superconducting pathways between them, consistent with exemplary aspects of certain implementations of the disclosed technology. The number of such superconducting quantum wave shutters in a multiplexer may be limited only by the ratio of the chip size and/or the structure width of the integrated devices. The quantum waves may become multiplexed from the free source (S) 615 of the lower left superconducting quantum wave shutter 604 to the several drains (D) 630A, 630B . . . 630n of the upper row of the superconducting quantum wave shutters 620A, 620B . . . 620n. A quantum wave multiplex results in entangled wave functions for each of the outlets (D) 630A, 630B . . . 630n.

### Superconducting Quantum Wave Memory (SQWM)

Quantum waves in superconductors may be propagating at nearly the speed of light. In order to maintain stable conditions in a quantum wave circuit, a system may either switch around with high frequencies, such as the system used for the high-performance data processing parts of the disclosed superconducting systems on a chip, or induce the quantum waves into a closed loop of superconductivity. In such a condition, the waveforms may flatten out over time but the inherent strength of the superconducting current may stay very precise due to the conservation laws of energy and/or of momentum and/or the lack of dissipation of the electrons within the superconducting quantum wave. FIG. 7 depicts one such exemplary superconducting quantum wave memory cell that stores quantum information within the direct current of the superconducting electrons, consistent with exemplary aspects of certain implementations of the disclosed technology.

In some illustrative implementations, such as the example of FIG. 7, a superconducting quantum wave memory device may be constructed of a direct current quantum wave resonator comprising a wide superconducting circuit path 780 and a narrow superconducting circuit path 790. The input and output of the quantum waves may be provided by the combined drain/source electrodes 730 that are connected via narrow superconducting circuit paths 770 to a quantum wave resonator. In one embodiment, the superconductivity capabilities of all three narrow circuit paths 770 and/or 790 may be controlled by device-embedded gate electrodes 750 for the source/drain paths and/or by device-embedded gate electrodes 760 for the resonator path. The aforementioned components may be surrounded by electrically isolating metal oxide 720.

The function of the whole superconducting quantum wave memory device may be as a quantum wave storage that preserves the information about the direction and strength of the induced direct superconducting current via the source electrodes 730. In one example, a short pulse of an electron quantum wave travelling from left to right into the storage cell/structure, such as a loop, ring, etc. (e.g., composed of resonator 780 and/or 790 in the illustrated example), may remain there as soon as gate electrodes 750 interrupt superconducting narrow paths 770. In this example, while the momentum of the quantum wave (which correlates to current strength) is being stored within resonator 780 and/or 790, resonator gates 760 may leave the narrow path in the superconducting state. In such a manner, the quantum wave resonator is able to precisely store the direction and/or strength of the superconducting current without dissipation. Since the superconducting electrons do not interact with their environment (e.g., the crystal lattice, etc.), they may be purely quantum mechanical objects, not maintaining a specific point in space-time. The superconducting electrons may be delocalized. This may give the superconducting quantum wave memory the ability to store such electron quantum waves in multiple modes within the resonator. Modes which come in via both of the source electrodes 730 simultaneously may be stored side by side in the resonator. Such modes may represent opposite directions of the electrical superconducting current.

Further, in some implementations, in order to read out the stored currents, both the superconducting electrodes 730 may be switched to drain by another superconducting quantum wave shutter and the source/drain gates 750 may be set to open while synchronously the resonator gates 760 close. Both modes of the quantum waves may simultaneously leave the resonator via the open paths 770 and electrodes 730 that are now switched to drain. A consecutive measurement of the current behind the superconducting quantum wave memory may determine the information about the direction and/or the strength of the current that has previously been stored by the superconducting quantum wave memory. Such superconducting quantum wave memory is then ready for another cycle of quantum wave storage with electrodes 730 switched to source.

### Direct Current Superconducting Qubits (DCSQ)

The direct current superconducting qubits may comprise or consist of a quantum wave multiplexer with multiple drain outlets (e.g., two drain outlets) and a superconducting quantum wave memory. The quantum wave multiplexer may receive a superconducting electron pulse from a high-frequency generator and/or a signal chopper and split the electronic waves into two circuit paths. This entangles both quantum waves within the superconducting paths which are then propagated to the source electrodes of the superconducting quantum wave memory. The source/drain gate electrodes of the superconducting quantum wave memory are synchronized with the QWMX and momentarily open the superconducting path to the previously relaxed resonator. This may create a qubit within the resonator where the quantum information is stored within the coherent superconducting currents which are then superpositioned. In some embodiments, the phase of the qubit may be defined according to the strength and phase of the current. For example, synchronous pulses in both directions of the resonator circuit path may represent a qubit initialized with a zero-state vector followed by a Hadamard gate. The readout of the DCSQ may function according to the readout procedure of the superconducting quantum wave memory. In the case of the DCSQ, this readout may provide only one direction of the superconducting current previously stored in the resonator of the superconducting quantum wave memory, since the inserted quantum waves have been entangled. This may lead to the classical information of the measurement of the qubit, where one direction of the current is interpreted as the 0 and the opposite as the 1 value of the resulting classical bit.

Quantum Gate and Circuit implementations In order to create a quantum register (e.g., 380 in FIG. 3, etc.), universal quantum gates and circuits may be built using the quantum wave multiplexer to initialize and entangle more than one qubit. According to the ratios of the amplitudes of the superconducting currents induced into the superconducting quantum wave memory and the paths and/or phases of the electron quantum waves through arbitrarily connected and switched QWMX (e.g., 385 in FIG. 3, etc.), any sequence of controlled CNOT and rotation gates may be applied to the initialized qubits in the superconducting quantum wave memory. Additionally, any feedback cycles, as well as pre- and/or post-processing capabilities (e.g., performed via circuits/components within 390 in FIG. 3, etc.) may be implemented with further superconducting quantum wave circuits based on the SQWS devices. In some embodiments, such devices residing on other chips may be attached via the quantum system bus connector (e.g., 395 in FIG. 3, etc.), also based on the superconducting quantum wave shutter, the SQMX and/or the superconducting quantum wave memory. The systems described herein enables the whole implementation of chip-level integrated electron quantum wave systems to a highly scalable and/or fault tolerant universal quantum information processing device.

### Various Implementations of the Disclosed Technology

As disclosed herein, implementations and features of the present inventions may be implemented through computer hardware, software and/or firmware, including, for example, in any Hardware Description Language (HDL) or simulation, emulation, etc. For example, the systems and methods disclosed herein may be embodied in various forms including, for example, one or more data processors, such as computer(s), server(s), and the like, and may also include or access at least one database, digital electronic circuitry, firmware, software, or in combinations of them. Further, while some of the disclosed implementations describe specific (e.g., hardware, etc.) components, systems, and methods consistent with the innovations herein may be implemented with any combination of hardware, software and/or firmware.

Here, as set forth in additional detail above, the exemplary semiconductor techniques and substrates that may be utilized, herein, include any existing technologies and materials capable of producing structures and circuit components in the nanometer range, such as metal oxide semiconductor (MOS) fabrication systems and methods (e.g., CMOS, NMOS, etc.), and other chip platforms, such as diamond-, graphene- and other recent and future material-based technologies that achieve such nanometer-scale superconductor platform(s) and device parameters and characteristics.

Moreover, the above-noted features and other aspects and principles of the innovations herein may be implemented in various environments. Such environments and related applications may be specially constructed for performing the various processes and operations according to the inventions or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the inventions, or it may be more convenient to construct a specialized apparatus or system to perform the required methods and techniques.

In the present description, the terms component, module, device, etc. may refer to any type of logical or functional device, process or blocks that may be implemented in a variety of ways. For example, the functions of various blocks can be combined with one another and/or distributed into any other number of modules. Each module can be implemented as a software program stored on a tangible memory (e.g., random access memory, read only memory, CD-ROM memory, hard disk drive) within or associated with the computing elements, sensors, receivers, etc. disclosed above, e.g., to be read by a processing unit to implement the functions of the innovations herein. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices, standard cell-based devices, application specific integrated circuits and/or any type of quantum information storing or processing device. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy logic, neural networks, other AI (Artificial Intelligence) or machine learning systems, quantum devices, and hybrids of any of the above device types.

It should also be noted that various logic and/or features disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in tangible various forms (e.g., optical, magnetic or semiconductor storage media), though do not encompass transitory media.

Realizations of the subject matter of the disclosed technology include, but are not limited to, the following examples:

A hybrid integrated superconducting system on at least one substrate, the system having both classical signal processing and/or computation architecture and quantum signal processing and/or computation architecture integrated on the at least one substrate, the system comprising:
one or more superconductor components on the at least one substrate that is formed of non-superconducting material, the one or more superconductor components comprising: a classical computing system comprised of classical signal and data processing architectures; a quantum computing system comprised of quantum wave and information processing architectures; and/or a signal conversion subsystem integrated on the single die, the subsystem coupled between the classical computing system and the quantum computing system and comprised of circuitry and components that perform conversion of first electrical signals of classical computing system and conversion of second quantum signals of the quantum computing system; wherein the classical computing system comprises classical computing components including two or more of: one or more classical core processing units; a high frequency clock that provides a clock signal to the one or more classical core processing units; at least one classical memory device coupled to the one or more classical core processing units and configured to store superconducting system information in classical format as first data; and/or a classical system bus connecting two or more of the classical components; wherein the quantum computing system comprises quantum components including two or more of: at least one quantum multiplexer; one or more qubit registers coupled to the quantum multiplexer; one or more quantum controller cores coupled to the at least one quantum multiplexer and configured to: (i) store the superconducting system information in quantum format as second data, and/or (ii) exchange the superconducting system information with the at least one classical memory device via the signal conversion subsystem; and a quantum system bus connector that connects two or more of the quantum components; wherein the signal conversion subsystem comprises: a switching device, which receives the first electrical signals and the second quantum signals and produces one or more output signals responsive thereto, the switching device integrated into the at least one substrate and, optionally, comprising: at least one resonator into which electron quantum waves of the second quantum signals travel; and/or superconducting quantum wave shutters comprised of one or more source electrodes and one or more resonator gates; wherein the switching device contains shutter circuit modules of the wave shutters arranged together, each shutter circuit module comprising at least a subset of the wave shutters coupled together in one or more cascaded formations; wherein, to generate output signals for use in the classical computing system from the second quantum signals, the shutter circuit modules are arranged and structures of the wave shutters are connected to: receive, from the one or more source electrodes, the electron quantum waves into the at least one resonator; and/or generate the output signals responsive to interactions of the electron quantum waves with the one or more resonator gates, the wave shutters and/or the one or more cascaded formations of the shutter circuit modules.

Systems herein, wherein the at least one substrate: consists of a single die, or consists of a single chip, or comprises two or more interconnected elements, wherein the elements comprise (i) interconnected chips, (ii) interconnected dies, or (iii) at least one die interconnected with at least one chip.

A hybrid integrated superconducting system on a single chip or die, the system having both classical signal processing and/or computation architecture and quantum signal processing and/or computation architecture integrated on the single chip or die, the system comprising:
one or more superconductor components on a non-superconducting substrate, such as a superconductor Metal-Oxide-Semiconductor (SMOS) chip, wherein the chip is comprised of the one or more superconductor components residing on the die and having superconducting electrons are delocalized, wherein the one or more superconductor components comprise: a classical computing system comprised of classical signal and data processing architectures; a quantum computing system comprised of quantum wave and information processing architectures; a signal conversion subsystem integrated on the single die, the subsystem coupled between the classical computing system and the quantum computing system and comprised of circuitry and components that perform conversion of first electrical signals of classical computing system and conversion of second quantum signals of the quantum computing system; wherein the classical computing system comprises classical computing components including three or more of: one or more classical core processing units; a high frequency clock that provides a clock signal to the one or more classical core processing units; at least one classical memory device coupled to the one or more classical core processing units and configured to store superconducting system information in classical format as first data; and/or a classical system bus connecting two or more of the classical components; wherein the quantum computing system comprises quantum components including three or more of: at least one quantum multiplexer; one or more qubit registers coupled to the quantum multiplexer; one or more quantum controller cores coupled to the at least one quantum multiplexer and configured to: (i) store the superconducting system information in quantum format as second data, and/or (ii) exchange the superconducting system information with the at least one classical memory device via the signal conversion subsystem; and a quantum system bus connector that connects two or more of the quantum components; wherein the signal conversion subsystem comprises: a switching device, which receives the first electrical signals and the second quantum signals and produces one or more output signals responsive thereto, the switching device integrated into the single die of the SMOS chip and comprising: at least one resonator into which electron quantum waves of the second quantum signals travel; and/or superconducting quantum wave shutters comprised of one or more source electrodes and one or more resonator gates; wherein the switching device contains shutter circuit modules of the wave shutters arranged together, each shutter circuit module comprising at least a subset of the wave shutters coupled together in one or more cascaded formations; wherein, to generate output signals for use in the classical computing system from the second quantum signals, the shutter circuit modules are arranged and structures of the wave shutters are connected to: receive, from the one or more source electrodes, the electron quantum waves into the at least one resonator; and generate the output signals responsive to interactions of the electron quantum waves with the one or more resonator gates, the wave shutters and/or the one or more cascaded formations of the shutter circuit modules.

A hybrid integrated superconducting system on a chip having both classical signal processing and/or computation architecture and quantum signal processing and/or computation architecture integrated on a single die, the system comprising: a superconductor Metal-Oxide-Semiconductor (SMOS) chip containing the single die, the chip comprised of one or more superconducting components residing on the single die and having superconducting electrons that are delocalized, wherein and the one or more superconducting components comprise: a classical computing system comprised of classical signal and data processing architectures and being driven by at least one voltage source; a quantum computing system comprised of quantum wave and information processing architectures and being driven by at least one current source; a signal conversion subsystem integrated on the die, coupled between the classical computing system and the quantum computing system, and comprised of circuitry and components that perform voltage-to-current conversion of first electrical signals of classical computing system and current-to-voltage conversion of second quantum signals of the quantum computing system; wherein the classical computing system comprises classical components including: one or more classical core processing units; a high frequency clock that provides a clock signal to the one or more classical core processing units; at least one classical memory device coupled to the one or more classical core processing units and configured to store superconducting system information in classical format as first data; and a classical system bus connecting two or more of the classical components; wherein the quantum computing system comprises quantum components including: at least one quantum multiplexer; one or more qubit registers coupled to the quantum multiplexer and receiving the clock signal from the high frequency clock; one or more quantum controller cores coupled to the at least one quantum multiplexer and configured to: (i) store the superconducting system information in quantum format as second data, and (ii) exchange the superconducting system information with the at least one classical memory device via the signal conversion subsystem; and a quantum system bus connector that connects two or more of the quantum components; wherein the signal conversion subsystem comprises: a switching device, which receives the first electrical signals and the second quantum signals and produces output signals responsive thereto, wherein the switching device is integrated into the single die and comprises: at least one resonator into which electron quantum waves of the second quantum signals travel; and superconducting quantum wave shutters comprised of one or more source electrodes and one or more resonator gates; wherein the switching device contains shutter circuit modules of the wave shutters arranged together, each shutter circuit module comprising a subset of the wave shutters coupled together in one or more cascaded formations including sources or drains of a plurality of the shutters electrically coupled together; wherein, to generate output signals for use in the classical computing system from the second quantum signals, the shutter circuit modules are arranged and structures of the wave shutters are connected to: receive, from the one or more source electrodes, the electron quantum waves into the at least one resonator; and/or generate the output signals, as classical computing signals, responsive to interactions of the electron quantum waves with the one or more resonator gates, the wave shutters and/or the one or more cascaded formations of the shutter circuit modules.

A hybrid integrated superconducting system on a chip having both classical signal processing and/or computation architecture and quantum signal processing and/or computation architecture integrated on a single die, the system comprising: an integrated cryogenic shielded package; and a Superconductor-Metal-Oxide-Semiconductor (SMOS) chip within the shielding package and containing one or more superconducting components on the single die, wherein the one or more superconducting components have superconducting electrons that are delocalized and the one or more superconducting components comprise: a classical computing system comprised of classical signal and data processing architectures and being driven by at least one voltage source; a quantum computing system comprised of quantum wave and information processing architectures and being driven by at least one current source; a signal conversion subsystem integrated on the die, coupled between the classical computing system and the quantum computing system, and comprised of circuitry and components that perform voltage-to-current conversion of first electrical signals of classical computing system and current-to-voltage conversion of second quantum signals of the quantum computing system; wherein the classical computing system comprises classical components including: one or more classical core processing units; a high frequency clock that provides a clock signal to the one or more classical core processing units; at least one classical memory device coupled to the one or more classical core processing units and configured to store superconducting system information in classical format as first data; and a classical system bus connecting two or more of the classical components; wherein the quantum computing system comprises quantum components including: at least one quantum multiplexer; one or more qubit registers coupled to the quantum multiplexer and receiving the clock signal from the high frequency clock; one or more quantum controller cores coupled to the at least one quantum multiplexer and configured to: (i) store the superconducting system information in quantum format as second data, and (ii) exchange the superconducting system information with the at least one classical memory device via the signal conversion subsystem; and a quantum system bus connector that connects two or more of the quantum components; wherein the signal conversion subsystem comprises: a switching device, which receives the first electrical signals and the second quantum signals and produces output signals responsive thereto, wherein the switching device is integrated into the single die and comprises: at least one resonator into which electron quantum waves of the second quantum signals travel; and superconducting quantum wave shutters comprised of one or more source electrodes and one or more resonator gates; wherein the switching device contains shutter circuit modules (e.g., FIG. 6, etc.) of the wave shutters arranged together, each shutter circuit module comprising a subset of the wave shutters coupled together in one or more cascaded formations including sources or drains of a plurality of the shutters electrically coupled together; wherein, to generate output signals for use in the classical computing system from the second quantum signals, the shutter circuit modules are arranged and structures of the wave shutters are connected to: receive, from the one or more source electrodes, the electron quantum waves into the at least one resonator; and generate the output signals, as classical computing signals, responsive to interactions of the electron quantum waves with the one or more resonator gates, the wave shutters and/or the one or more cascaded formations of the shutter circuit modules.

Systems herein, wherein the shutter circuit modules are arranged to form one or more quantum wave multiplexers.

Systems herein, wherein the one or more quantum wave multiplexers each comprise three or more of the wave shutters.

Systems herein, wherein the switching device utilizes the delocalized property of superconducting electrons as quantum waves to switch the wave shutters within the switching device.

Systems herein, wherein the shutter circuit modules and/or the wave shutters are interconnected in one or more arrangements, within at least one component, subcomponent and/or circuit of the quantum computing system, such that associated output(s) of the one or more arrangements provide one or more of quantum wave distribution, superposition (interference) and/or entanglement.

Systems herein, wherein the shutter circuit modules and/or the wave shutters are interconnected in one or more arrangements, within at least one component, subcomponent and/or circuit of the quantum computing system, such that associated output(s) of the one or more arrangements provide two or more of quantum wave distribution, superposition (interference) and/or entanglement at a same time.

Systems herein, wherein the shutter circuit modules and/or the wave shutters are interconnected in one or more arrangements, within at least one component, subcomponent and/or circuit of the quantum computing system, such that associated output(s) of the one or more arrangements provide quantum wave distribution, superposition (interference) and entanglement at a same time.

Systems herein, wherein the shutter circuit modules and/or the wave shutters are arranged the quantum computing system such that one or more signals and/or outputs associated therewith provide for one or more of quantum wave distribution, superposition (interference) and/or entanglement.

Systems herein, wherein the shutter circuit modules and/or the wave shutters are arranged the quantum computing system such that one or more signals and/or outputs associated therewith provide for two or more of, or three or more of, quantum wave distribution, superposition (interference) and/or entanglement at a same time.

Systems herein, wherein the one or more cascaded formations include at least one set of wave shutters (SQWSs, e.g., FIGS. 4-5, etc,) arranging to multiplex the electron quantum waves, such as from a free source (S, 615) on an inlet end (e.g., lower left of the example quantum multiplexer QWMX 385 component shown in FIG. 6, etc.) to one or more drains (D, e.g., 630A, 630B . . . 630n, etc.) towards an outlet (such as outlets of the upper row of the SQWSs of FIG. 6, e.g., 620A, 620B . . . 620n, etc.) of each multiplex formation, thereby providing quantum wave multiplex outputs having entangled wave functions for each outlets (e.g., 630A, 630B . . . 630n, etc.).

Systems herein, wherein the one or more cascaded formations include sources or drains of a plurality of the wave shutters coupled together and the wave shutters connected to provide multiplexing of the quantum wave signals such that quantum wave distribution and entanglement are provided at a same time.

Systems herein, wherein each of the quantum wave shutters comprise only one single source.

Systems herein, wherein each of the quantum wave memory cells comprise two sources, or consist of two sources.

Systems herein, further comprising a multi-qubit controlled NOT (CNOT) implementation, further comprising: a quantum wave multiplexer that provides entangled electron quantum waves used as input to at least one of the quantum wave memories (e.g., within 380 and constructed, e.g., of the devices of FIG. 7, etc.); and/or wherein at least two of the source electrodes at the at least one of the quantum wave memories are configured with amplitude ratio control to provide a rotation gate implementation of the at least one of the quantum wave memories.

Systems herein, wherein the quantum multiplexer (QWMX 385), the quantum wave memory (SQWM, e.g., devices of FIG. 7 within 380, etc.), and/or the quantum multiplexer (QWMX) in combination with the quantum memory (SQWM): comprise(s) universal quantum gates and/or circuits that are arranged and/or connected to initialize and entangle more than one qubit in the qubit registers; and/or provide(s), to the one or more quantum controller cores, outputs characterized by amplitudes of superconducting currents induced into the one or more quantum controller cores; wherein, as a function of (i) ratios of the amplitudes of the superconducting currents induced into the one or more qubit registers, and/or (ii) paths and/or phases of the electron quantum waves through the quantum multiplexer, a sequence of controlled CNOT and rotation gates are applied to initialized qubit states in the qubit register.

Systems herein, wherein feedback cycles, pre-processing capabilities, and/or post-processing capabilities at the quantum controller cores (390) are implemented via superconducting quantum wave circuits comprising one or both of the wave shutter devices (e.g., FIGS. 4-5, etc.) and/or quantum memory devices (such as those constructed, e.g., of the memory elements of FIG. 7, etc).

Systems herein, wherein the electron quantum waves are split into a plurality of pathways, wherein each of the plurality of pathways is controlled by respective one or ones of the wave shutters that are synchronized, such as by, e.g., gate-synchronized wave shutters, etc.

Systems herein, wherein each of the plurality of pathways are controlled by respective multiplexers, with each multiplexer including one or more of the wave shutters that are synchronized, such as having gate-synchronized wave shutters.

Systems herein, wherein the at least one resonator comprises direct current quantum wave resonators, each including a wide superconducting circuit path and a narrow superconducting circuit path.

Systems herein, wherein each of the quantum wave shutters comprises: a substrate comprised of switching elements; wherein each of the switching elements include: at least one gate, at least one source, and at least one drain, wherein the gate is comprised of a semiconductor material that switches flow of current between on and off via application of a gate voltage to the gate; and/or a source-drain passageway in the substrate between the source and the drain, the source-drain passageway including a first (e.g., broader, etc.) source-drain passage, portion or structure (e.g., 440, 430, etc.) that includes and is interrupted by a second source-drain passage, portion or structure (e.g., 470, etc.) that is physically different (e.g., in structure, physics, operation, shape, such as narrower, etc.) than the first source-drain passage, portion or structure and formed with or as truncated or attenuated portion or end such that the second source-drain passage, portion or structure is sensitive to electrical fields of the gate voltage for superconductivity of the switching elements to be switched on and off, accordingly.

Systems herein, wherein the source-drain passageway comprises a subsection that forms the second source-drain passage, portion or structure, the subsection comprising a substantially thin portion (470) being of a superconducting material having a thinner or smaller dimension between a first gate (upper gate, 450) and a second gate (lower gate, 460) that receive voltage to provide an electrical field to the thin portion between the source and drain.

Systems herein, wherein the superconducting quantum wave memory comprises: a combination of two superconducting wave shutters which are in parallel connected with their drains to a superconducting loop which comprises a first (e.g., broad, etc.) circuit path connected with a second circuit path, which differs form the first circuit path (e.g., is narrower than or otherwise differs in structure, physics, operation, shape, etc.), wherein superconductivity of the combination is sensitive to an electrical field of two additional electrodes (760).

Systems herein, wherein the source-drain passageway comprises a substantially circular, loop or ring shape, with the second source-drain passage, portion or structure being formed as a substantially straight portion (790) of the substantially circular, loop or ring shape that truncates an edge of the shape, to yield a flattened edge of said substantial circle.

Systems herein, wherein the quantum wave shutters comprise the wave shutter of one or both paragraph [79] or [80].

A superconducting quantum wave shutter comprising: a substrate comprised of switching elements; wherein each of the switching elements include: at least one gate, at least one source, and at least one drain, wherein the gate is comprised of a semiconductor material that switches flow of current between on and off via application of a gate voltage to the gate; and/or a source-drain passageway in the substrate between the source and the drain, the source-drain passageway including a first (e.g., broader, etc.) source-drain passage, portion or structure (e.g., 440, 430, etc.) that includes and is interrupted by a second source-drain passage, portion or structure (e.g., 470, etc.) that is physically different (e.g., in structure, physics, operation, shape, such as narrower, etc.) than the first source-drain passage, portion or structure and formed as truncated or attenuated portion or end such that the second source-drain passage, portion or structure is sensitive to electrical fields of the gate voltage for superconductivity of the switching elements to be switched on and off, accordingly.

A superconducting quantum wave shutter herein, wherein the source-drain passageway comprises a subsection that forms the second source-drain passage, portion or structure, the subsection comprising a substantially thin portion (470) being of a superconducting material having a thinner or smaller dimension between a first gate (upper gate, 450) and a second gate (lower gate, 460) that receive voltage to provide an electrical field to the thin portion between the source and drain.

A superconducting quantum wave memory (e.g., FIG. 7) comprising: a combination of two superconducting wave shutters which are in parallel connected with their drains to a superconducting loop which comprises a first (broad) circuit path connected with a second (narrow) circuit path, which is narrower than the first circuit path, wherein superconductivity of the combination is sensitive to an electrical field of two additional electrodes (760).

A superconducting quantum wave memory herein, wherein the source-drain passageway comprises a substantially circular, loop or ring shape, with the second source-drain passage, portion or structure being formed as a substantially straight portion (790) of the substantially circular shape that truncates an edge of the shape, to yield a flattened edge of said substantial circle.

A superconducting quantum wave memory herein, wherein the quantum wave shutters comprise the wave shutter of one or both of paragraph [84] and/or [85].

An integrated cryogenic radiation-shielded package having a vacuum chamber, the package comprising one or more of: a chip, such as a superconductor Metal-Oxide-Semiconductor (SMOS) chip within the shielding package and containing one or more superconducting components on a single die, wherein the one or more superconducting components have superconducting electrons that are delocalized and the one or more superconducting components comprise: a classical computing system comprised of classical signal and data processing architectures; a quantum computing system comprised of quantum wave and information processing architectures; and a signal conversion subsystem integrated on the single die, the subsystem coupled between the classical computing system and the quantum computing system and comprised of circuitry and components that perform conversion of first electrical signals of classical computing system and conversion of second quantum signals of the quantum computing system; one or more first sending and receiving devices on the chip; one or more second receiving and receiving devices located on the package; and/or one or more electromagnetic/photonic coupling channels, which couple the chip across a gap of the vacuum to circuitry external to the package via transmission of electromagnetic radiation (e.g., microwave, light, photonic, etc.), wherein each of the channels bridges the gap between a sending or receiving device on the chip and its paired receiving or sending device on the package.

An integrated cryogenic radiation-shielded package herein, further comprising: an electromagnetic induction system (180) by which the superconducting chip receives its energy to operate.

An integrated cryogenic radiation-shielded package herein, wherein one or more of the classical computing system comprises classical computing components including two or more of one or more classical core processing units; a high frequency clock that provides a clock signal to the one or more classical core processing units; at least one classical memory device coupled to the one or more classical core processing units and configured to store superconducting system information in classical format as first data; and/or a classical system bus connecting two or more of the classical components; the quantum computing system comprises quantum components including two or more of: at least one quantum multiplexer; one or more qubit registers coupled to the quantum multiplexer; one or more quantum controller cores coupled to the at least one quantum multiplexer and configured to: (i) store the superconducting system information in quantum format as second data, and/or (ii) exchange the superconducting system information with the at least one classical memory device via the signal conversion subsystem; and a quantum system bus connector that connects two or more of the quantum components; and/or the signal conversion subsystem comprises: a switching device, which receives the first electrical signals and the second quantum signals and produces one or more output signals responsive thereto, the switching device integrated into the single die of the SMOS chip and comprising: at least one resonator into which electron quantum waves of the second quantum signals travel; and/or superconducting quantum wave shutters comprised of one or more source electrodes and one or more resonator gates; wherein the switching device contains shutter circuit modules of the wave shutters arranged together, each shutter circuit module comprising at least a subset of the wave shutters coupled together in one or more cascaded formations; wherein, to generate output signals for use in the classical computing system from the second quantum signals, the shutter circuit modules are arranged and structures of the wave shutters are connected to: receive, from the one or more source electrodes, the electron quantum waves into the at least one resonator; and/or generate the output signals responsive to interactions of the electron quantum waves with the one or more resonator gates, the wave shutters and/or the one or more cascaded formations of the shutter circuit modules.

Other implementations of the inventions will be apparent to those skilled in the art from consideration of the specification and practice of the innovations disclosed herein. It is intended that the specification and examples be considered as exemplary only, with a true scope and spirit of the inventions being indicated by the present disclosure and various associated principles of related patent doctrine.

1. A hybrid integrated superconducting system on at least one substrate, the system having both classical signal processing and/or computation architecture and quantum signal processing and/or computation architecture integrated on the at least one substrate, the system comprising:
one or more superconductor components on the at least one substrate that is formed of non-superconducting material, the one or more superconductor components comprising:
a classical computing system comprised of classical signal and data processing architectures;
a quantum computing system comprised of quantum wave and information processing architectures;
a signal conversion subsystem integrated on the single die, the subsystem coupled between the classical computing system and the quantum computing system and comprised of circuitry and components that perform conversion of first electrical signals of classical computing system and conversion of second quantum signals of the quantum computing system;
wherein the classical computing system comprises classical computing components including two or more of:
one or more classical core processing units;
a high frequency clock that provides a clock signal to the one or more classical core processing units;
at least one classical memory device coupled to the one or more classical core processing units and configured to store superconducting system information in classical format as first data; and/or
a classical system bus connecting two or more of the classical components;
wherein the quantum computing system comprises quantum components including two or more of:
at least one quantum multiplexer;
one or more qubit registers coupled to the quantum multiplexer;
one or more quantum controller cores coupled to the at least one quantum multiplexer and configured to: (i) store the superconducting system information in quantum format as second data, and/or (ii) exchange the superconducting system information with the at least one classical memory device via the signal conversion subsystem; and/or
a quantum system bus connector that connects two or more of the quantum components;
wherein the signal conversion subsystem comprises:
a switching device, which receives the first electrical signals and the second quantum signals and produces one or more output signals responsive thereto, the switching device integrated into the at least one substrate and comprising:
at least one resonator into which electron quantum waves of the second quantum signals travel; and/or
superconducting quantum wave shutters comprised of one or more source electrodes and one or more resonator gates;
wherein the switching device contains shutter circuit modules of the wave shutters arranged together, each shutter circuit module comprising at least a subset of the wave shutters coupled together in one or more cascaded formations;
wherein, to generate output signals for use in the classical computing system from the second quantum signals, the shutter circuit modules are arranged and structures of the wave shutters are connected to:
receive, from the one or more source electrodes, the electron quantum waves into the at least one resonator; and/or
generate the output signals responsive to interactions of the electron quantum waves with the one or more resonator gates, the wave shutters and/or the one or more cascaded formations of the shutter circuit modules.

2. The system of claim 1 or the invention of any claim herein, wherein the at least one substrate consists of a single die.

3. The system of claim 1 or the invention of any claim herein, wherein the at least one substrate consists of a single chip.

4. The system of claim 1 or the invention of any claim herein, wherein the at least one substrate comprises two or more interconnected elements, wherein the elements comprise (i) interconnected chips, (ii) interconnected dies, or (iii) at least one die interconnected with at least one chip.

5. A hybrid integrated superconducting system on a single chip or die, the system having both classical signal processing and/or computation architecture and quantum signal processing and/or computation architecture integrated on the single chip or die, the system comprising:
one or more superconductor components on a non-superconducting substrate, such as a superconductor Metal-Oxide-Semiconductor (SMOS) chip, wherein the chip is comprised of the one or more superconductor components residing on the die and having superconducting electrons are delocalized, wherein the one or more superconductor components comprise:
a classical computing system comprised of classical signal and data processing architectures;
a quantum computing system comprised of quantum wave and information processing architectures;
a signal conversion subsystem integrated on the single die, the subsystem coupled between the classical computing system and the quantum computing system and comprised of circuitry and components that perform conversion of first electrical signals of classical computing system and conversion of second quantum signals of the quantum computing system;
wherein the classical computing system comprises classical computing components including three or more of:
one or more classical core processing units;
a high frequency clock that provides a clock signal to the one or more classical core processing units;
at least one classical memory device coupled to the one or more classical core processing units and configured to store superconducting system information in classical format as first data; and/or
a classical system bus connecting two or more of the classical components;
wherein the quantum computing system comprises quantum components including three or more of:
at least one quantum multiplexer;
one or more qubit registers coupled to the quantum multiplexer;
one or more quantum controller cores coupled to the at least one quantum multiplexer and configured to: (i) store the superconducting system information in quantum format as second data, and/or (ii) exchange the superconducting system information with the at least one classical memory device via the signal conversion subsystem; and
a quantum system bus connector that connects two or more of the quantum components;
wherein the signal conversion subsystem comprises:
a switching device, which receives the first electrical signals and the second quantum signals and produces one or more output signals responsive thereto, the switching device integrated into the single die of the SMOS chip and comprising:
at least one resonator into which electron quantum waves of the second quantum signals travel; and
superconducting quantum wave shutters comprised of one or more source electrodes and one or more resonator gates;
wherein the switching device contains shutter circuit modules of the wave shutters arranged together, each shutter circuit module comprising at least a subset of the wave shutters coupled together in one or more cascaded formations;
wherein, to generate output signals for use in the classical computing system from the second quantum signals, the shutter circuit modules are arranged and structures of the wave shutters are connected to:
receive, from the one or more source electrodes, the electron quantum waves into the at least one resonator; and
generate the output signals responsive to interactions of the electron quantum waves with the one or more resonator gates, the wave shutters and/or the one or more cascaded formations of the shutter circuit modules.

6. A hybrid integrated superconducting system on a chip having both classical signal processing and/or computation architecture and quantum signal processing and/or computation architecture integrated on a single die, the system comprising:
a superconductor Metal-Oxide-Semiconductor (SMOS) chip containing the single die, the chip comprised of one or more superconducting components residing on the single die and having superconducting electrons that are delocalized, wherein and the one or more superconducting components comprise:
a classical computing system comprised of classical signal and data processing architectures and being driven by at least one voltage source;
a quantum computing system comprised of quantum wave and information processing architectures and being driven by at least one current source;
a signal conversion subsystem integrated on the die, coupled between the classical computing system and the quantum computing system, and comprised of circuitry and components that perform voltage-to-current conversion of first electrical signals of classical computing system and current-to-voltage conversion of second quantum signals of the quantum computing system;
wherein the classical computing system comprises classical components including:
one or more classical core processing units;
a high frequency clock that provides a clock signal to the one or more classical core processing units;
at least one classical memory device coupled to the one or more classical core processing units and configured to store superconducting system information in classical format as first data; and
a classical system bus connecting two or more of the classical components;
wherein the quantum computing system comprises quantum components including:
at least one quantum multiplexer;
one or more qubit registers coupled to the quantum multiplexer and receiving the clock signal from the high frequency clock;
one or more quantum controller cores coupled to the at least one quantum multiplexer and configured to: (i) store the superconducting system information in quantum format as second data, and (ii) exchange the superconducting system information with the at least one classical memory device via the signal conversion subsystem; and
a quantum system bus connector that connects two or more of the quantum components;
wherein the signal conversion subsystem comprises:
a switching device, which receives the first electrical signals and the second quantum signals and produces output signals responsive thereto, wherein the switching device is integrated into the single die and comprises:
at least one resonator into which electron quantum waves of the second quantum signals travel; and
superconducting quantum wave shutters comprised of one or more source electrodes and one or more resonator gates;
wherein the switching device contains shutter circuit modules of the wave shutters arranged together, each shutter circuit module comprising a subset of the wave shutters coupled together in one or more cascaded formations including sources or drains of a plurality of the shutters electrically coupled together;
wherein, to generate output signals for use in the classical computing system from the second quantum signals, the shutter circuit modules are arranged and structures of the wave shutters are connected to:
receive, from the one or more source electrodes, the electron quantum waves into the at least one resonator; and
generate the output signals, as classical computing signals, responsive to interactions of the electron quantum waves with the one or more resonator gates, the wave shutters and/or the one or more cascaded formations of the shutter circuit modules.

7. A hybrid integrated superconducting system on a chip having both classical signal processing and/or computation architecture and quantum signal processing and/or computation architecture integrated on a single die, the system comprising:
an integrated cryogenic shielded package; and
a superconductor Metal-Oxide-Semiconductor (SMOS) chip within the shielding package and containing one or more superconducting components on the single die, wherein the one or more superconducting components have superconducting electrons that are delocalized and the one or more superconducting components comprise:
a classical computing system comprised of classical signal and data processing architectures and being driven by at least one voltage source;
a quantum computing system comprised of quantum wave and information processing architectures and being driven by at least one current source;
a signal conversion subsystem integrated on the die, coupled between the classical computing system and the quantum computing system, and comprised of circuitry and components that perform voltage-to-current conversion of first electrical signals of classical computing system and current-to-voltage conversion of second quantum signals of the quantum computing system;
wherein the classical computing system comprises classical components including:
one or more classical core processing units;
a high frequency clock that provides a clock signal to the one or more classical core processing units;
at least one classical memory device coupled to the one or more classical core processing units and configured to store superconducting system information in classical format as first data; and
a classical system bus connecting two or more of the classical components;
wherein the quantum computing system comprises quantum components including:
at least one quantum multiplexer;
one or more qubit registers coupled to the quantum multiplexer and receiving the clock signal from the high frequency clock;
one or more quantum controller cores coupled to the at least one quantum multiplexer and configured to: (i) store the superconducting system information in quantum format as second data, and (ii) exchange the superconducting system information with the at least one classical memory device via the signal conversion subsystem; and
a quantum system bus connector that connects two or more of the quantum components;
wherein the signal conversion subsystem comprises:
a switching device, which receives the first electrical signals and the second quantum signals and produces output signals responsive thereto, wherein the switching device is integrated into the single die and comprises:
at least one resonator into which electron quantum waves of the second quantum signals travel; and
superconducting quantum wave shutters comprised of one or more source electrodes and one or more resonator gates;
wherein the switching device contains shutter circuit modules of the wave shutters arranged together, each shutter circuit module comprising a subset of the wave shutters coupled together in one or more cascaded formations including sources or drains of a plurality of the shutters electrically coupled together;
wherein, to generate output signals for use in the classical computing system from the second quantum signals, the shutter circuit modules are arranged and structures of the wave shutters are connected to:
receive, from the one or more source electrodes, the electron quantum waves into the at least one resonator; and
generate the output signals, as classical computing signals, responsive to interactions of the electron quantum waves with the one or more resonator gates, the wave shutters and/or the one or more cascaded formations of the shutter circuit modules.

8. The system of any one of claims 1-7 or the invention of any claim herein, wherein the shutter circuit modules are arranged to form one or more quantum wave multiplexers.

9. The system of any one of claims 1-8 or the invention of any claim herein, wherein the one or more quantum wave multiplexers each comprise three or more of the wave shutters.

10. The system of any one of claims 1-9 or the invention of any claim herein, wherein the switching device utilizes the delocalized property of superconducting electrons as quantum waves to switch the wave shutters within the switching device.

11. The system of any one of claims 1-10 or the invention of any claim herein, wherein the shutter circuit modules and/or the wave shutters are interconnected in one or more arrangements, within at least one component, subcomponent and/or circuit of the quantum computing system, such that associated output(s) of the one or more arrangements provide one or more of quantum wave distribution, superposition (interference) and/or entanglement.

12. The system of any one of claims 1-10 or the invention of any claim herein, wherein the shutter circuit modules and/or the wave shutters are interconnected in one or more arrangements, within at least one component, subcomponent and/or circuit of the quantum computing system, such that associated output(s) of the one or more arrangements provide two or more of quantum wave distribution, superposition (interference) and/or entanglement at a same time.

13. The system of any one of claims 1-10 or the invention of any claim herein, wherein the shutter circuit modules and/or the wave shutters are interconnected in one or more arrangements, within at least one component, subcomponent and/or circuit of the quantum computing system, such that associated output(s) of the one or more arrangements provide quantum wave distribution, superposition (interference) and entanglement at a same time.

14. The system of any one of claims 1-10 or the invention of any claim herein, wherein the shutter circuit modules and/or the wave shutters are arranged the quantum computing system such that one or more signals and/or outputs associated therewith provide for one or more of quantum wave distribution, superposition (interference) and/or entanglement.

15. The system of any one of claims 1-10 or the invention of any claim herein, wherein the shutter circuit modules and/or the wave shutters are arranged the quantum computing system such that one or more signals and/or outputs associated therewith provide for two or more of, or three or more of, quantum wave distribution, superposition (interference) and/or entanglement at a same time.

16. The system of any one of claims 1-15 or the invention of any claim herein, wherein the one or more cascaded formations include at least one set of wave shutters arranging to multiplex the electron quantum waves, such as from a free source or drain on an inlet end to one or more sources or drains towards or at an outlet/output of each multiplex formation, thereby providing quantum wave multiplex outputs having entangled wave functions for each outlets.

17. The system of any one of claims 1-16 or the invention of any claim herein, wherein the one or more cascaded formations include sources or drains of a plurality of the wave shutters coupled together and the wave shutters connected to provide multiplexing of the quantum wave signals such that quantum wave distribution and entanglement are provided at a same time.

18. The system of any one of claims 1-17 or the invention of any claim herein, wherein each of the quantum wave shutters comprise only one single source.

19. The system of any one of claims 1-18 or the invention of any claim herein, wherein each of the quantum wave memory cells comprise two sources, or consist of two sources.

20. The system of any one of claims 1-19 or the invention of any claim herein, further comprising a multi-qubit controlled NOT (CNOT) implementation, further comprising:
a quantum wave multiplexer that provides entangled electron quantum waves used as input to at least one of the quantum wave memories; and
wherein at least two of the source electrodes at the at least one of the quantum wave memories are configured with amplitude ratio control to provide a rotation gate implementation of the at least one of the quantum wave memories.

21. The system of any one of claims 1-20 or the invention of any claim herein, wherein the quantum multiplexer, the quantum memory, and/or the quantum multiplexer in combination with the quantum memory:
comprise(s) universal quantum gates and/or circuits that are arranged and/or connected to initialize and entangle more than one qubit in the qubit registers; and/or
provide(s), to the one or more quantum controller cores, outputs characterized by amplitudes of superconducting currents induced into the one or more quantum controller cores;
wherein, as a function of (i) ratios of the amplitudes of the superconducting currents induced into the one or more qubit registers, and/or (ii) paths and/or phases of the electron quantum waves through the quantum multiplexer, a sequence of controlled CNOT and rotation gates are applied to initialized qubit states in the qubit register.

22. The system of claim 21 or the invention of any claim herein, wherein feedback cycles, pre-processing capabilities, and/or post-processing capabilities at the quantum controller cores (390) are implemented via superconducting quantum wave circuits comprising one or both of the wave shutter devices and/or quantum memory devices.

23. The system of any one of claims 1-22, wherein the electron quantum waves are split into a plurality of pathways, wherein each of the plurality of pathways is controlled by respective one or ones of the wave shutters that are synchronized, such as by, e.g., gate-synchronized wave shutters, etc.

24. The system of claim 23 or the invention of any claim herein, wherein each of the plurality of pathways are controlled by respective multiplexers, with each multiplexer including one or more of the wave shutters that are synchronized, such as having gate-synchronized wave shutters.

25. The system of any one of claims 1-24 or the invention of any claim herein, wherein the at least one resonator comprises direct current quantum wave resonators, each including a wide superconducting circuit path and a narrow superconducting circuit path.

26. The system of any one of claims 1-25 or the invention of any claim herein, wherein each of the quantum wave shutters comprises:
a substrate comprised of switching elements;
wherein each of the switching elements include:
at least one gate, at least one source, and at least one drain, wherein the gate is comprised of a semiconductor material that switches flow of current between on and off via application of a gate voltage to the gate; and/or
a source-drain passageway in the substrate between the source and the drain, the source-drain passageway including a first source-drain passage, portion or structure that includes and is interrupted by a second source-drain passage, portion or structure that is physically different than the first source-drain passage, portion or structure and formed with or as a truncated or attenuated portion or end such that the second source-drain passage, portion or structure is sensitive to electrical fields of the gate voltage for superconductivity of the switching elements to be switched on and off, accordingly.

27. The system of claim 26 or the invention of any claim herein, wherein the source-drain passageway comprises a subsection that forms the second source-drain passage, portion or structure, the subsection comprising a substantially thin portion being of a superconducting material having a thinner or smaller dimension between a first gate and a second gate that receive voltage to provide an electrical field to the thin portion between the source and drain.

28. The system of any one of claims 1-27 or the invention of any claim herein, wherein the superconducting quantum wave memory comprises:
a combination of two superconducting wave shutters which are in parallel connected with their drains to a superconducting loop which comprises a first circuit path connected with a second circuit path, which differs form the first circuit path, wherein superconductivity of the combination is sensitive to an electrical field of two additional electrodes.

29. The system of claim 28 or the invention of any claim herein, wherein the source-drain passageway comprises a substantially circular, loop or ring shape, with the second source-drain passage, portion or structure being formed as a substantially straight portion of the substantially circular, loop or ring shape that truncates an edge of the shape, to yield a flattened edge of said substantial circle.

30. The system of claim 28 or the invention of any claim herein, wherein the quantum wave shutters comprise the wave shutter of one or both claim 26 and/or claim 27.

31. A superconducting quantum wave shutter comprising:
a substrate comprised of switching elements;
wherein each of the switching elements include:
at least one gate, at least one source, and at least one drain, wherein the gate is comprised of a semiconductor material that switches flow of current between on and off via application of a gate voltage to the gate; and/or
a source-drain passageway in the substrate between the source and the drain, the source-drain passageway including a first source-drain passage, portion or structure that includes and/or is interrupted by a second source-drain passage, portion or structure that is physically different than the first source-drain passage, portion or structure and, e.g., formed with or as truncated or attenuated portion or end such that the second source-drain passage, portion or structure is sensitive to electrical fields of the gate voltage for superconductivity of the switching elements to be switched on and off, accordingly.

32. The superconducting quantum wave shutter of claim 31 or the invention of any claim herein, wherein the source-drain passageway comprises a subsection that forms the second source-drain passage, portion or structure, the subsection comprising a substantially physically-different/thin portion being of a superconducting material having different dimension and/or physics between a first gate and a second gate that receive voltage to provide an electrical field to the thin portion between the source and drain.

33. A superconducting quantum wave memory comprising:
a combination of two superconducting wave shutters which are in parallel connected with their drains to a superconducting loop which comprises a first circuit path connected with a second circuit path, which, e.g., in some embodiments may be narrower than the first circuit path, and wherein superconductivity of the combination is sensitive to an electrical field of two additional electrodes.

34. The superconducting quantum wave memory of claim 33 or the invention of any claim herein, wherein the source-drain passageway comprises a substantially circular, loop or ring shape, with the second source-drain passage being formed as a substantially straight portion of the substantially circular shape that truncates an edge of the shape, to yield a flattened edge of said substantial circle.

35. The superconducting quantum wave memory of claim 33 or the invention of any claim herein, wherein the quantum wave shutters comprise the wave shutter of one or both of claim 31 and/or claim 32.

36. An integrated cryogenic radiation-shielded package having a vacuum chamber, the package comprising one or more of:
a chip, such as a superconductor Metal-Oxide-Semiconductor (SMOS) chip within the shielding package and containing one or more superconducting components on a single die, wherein the one or more superconducting components have superconducting electrons that are delocalized and the one or more superconducting components comprise:
a classical computing system comprised of classical signal and data processing architectures;
a quantum computing system comprised of quantum wave and information processing architectures; and/or
a signal conversion subsystem integrated on the single die, the subsystem coupled between the classical computing system and the quantum computing system and comprised of circuitry and components that perform conversion of first electrical signals of classical computing system and conversion of second quantum signals of the quantum computing system;
one or more first sending and receiving devices on the chip;
one or more second receiving and receiving devices located on the package; and/or
one or more electromagnetic/photonic coupling channels, which couple the chip across a gap of the vacuum to circuitry external to the package via transmission of electromagnetic radiation (e.g., microwave, light, photonic, etc.), wherein each of the channels bridges the gap between a sending or receiving device on the chip and its paired receiving or sending device on the package.

37. The package of claim 36 or the invention of any claim herein, further comprising:
an electromagnetic induction system by which the superconducting chip receives its energy to operate.

38. The package of claim 36 or the invention of any claim herein, wherein one or more of:
the classical computing system comprises classical computing components including two or more of:
one or more classical core processing units;
a high frequency clock that provides a clock signal to the one or more classical core processing units;
at least one classical memory device coupled to the one or more classical core processing units and configured to store superconducting system information in classical format as first data; and/or
a classical system bus connecting two or more of the classical components;
the quantum computing system comprises quantum components including two or more of:
at least one quantum multiplexer;
one or more qubit registers coupled to the quantum multiplexer;
one or more quantum controller cores coupled to the at least one quantum multiplexer and configured to: (i) store the superconducting system information in quantum format as second data, and/or (ii) exchange the superconducting system information with the at least one classical memory device via the signal conversion subsystem; and
a quantum system bus connector that connects two or more of the quantum components; and/or
the signal conversion subsystem comprises:
a switching device, which receives the first electrical signals and the second quantum signals and produces one or more output signals responsive thereto, the switching device integrated into the single die of the SMOS chip and comprising:
at least one resonator into which electron quantum waves of the second quantum signals travel; and
superconducting quantum wave shutters comprised of one or more source electrodes and one or more resonator gates;
wherein the switching device contains shutter circuit modules of the wave shutters arranged together, each shutter circuit module comprising at least a subset of the wave shutters coupled together in one or more cascaded formations;
wherein, to generate output signals for use in the classical computing system from the second quantum signals, the shutter circuit modules are arranged and structures of the wave shutters are connected to:
receive, from the one or more source electrodes, the electron quantum waves into the at least one resonator; and
generate the output signals responsive to interactions of the electron quantum waves with the one or more resonator gates, the wave shutters and/or the one or more cascaded formations of the shutter circuit modules.
